(19) United States
(12) Patent Application Publication
(10) Pub. No.: US 2005/0003180 A1
(43) Pub. Date: Jan. 6, 2005

(54) Moisture barrier compositions

(76) Inventor: Constantine A. Kondos, Pittsburgh, PA (US)

Correspondence Address: PPG INDUSTRIES, INC., Intellectual Property Department, One PPG Place, Pittsburgh, PA, 15272, US

(21) Appl. No.: 10/879,392

(22) Filed: Jun. 29, 2004

Related U.S. Application Data
(60) Provisional application No. 60/483,938, filed on Jul. 1, 2003.

(51) Int. Cl. B32B 5/16

(52) U.S. Cl. 428/324; 428/329; 428/328; 428/325; 106/404; 106/415

(57) ABSTRACT

A coating composition for applying to a substrate as a moisture barrier. The coating composition includes a styrenic polymer and metallic microparticles dispersed in the styrenic polymer. The coating composition has a moisture vapor transmission rate (MVTR) less than 0.95 g·mm/m²·day.

### RELATED APPLICATION

This application claims the benefit of U.S. Provisional Application No. 60/483,938, filed Jul. 1, 2003, incorporated herein by reference.

### FIELD OF THE INVENTION

The present invention relates to moisture barrier compositions, more particularly, to a coating composition for application to substrates for controlling transmission of water moisture to the substrate.

### BACKGROUND OF THE INVENTION

Coating compositions that act as a barrier to prevent or reduce contact of a substance with a substrate are commonly used in a variety of industries. In certain applications, the coating compositions act as a moisture barrier and are relatively inflexible, such as coatings used in the automobile and paint industries. However, in other applications where the substrate is flexible and/or resilient, such a moisture barrier should likewise be flexible and/or resilient in order to maintain the physical properties of the underlying substrate.

### SUMMARY OF THE INVENTION

The present invention provides a coating for applying to a substrate as a moisture barrier. The coating composition includes a binder containing a styrenic polymer and microparticles dispersed in the styrenic polymer. The coating composition has a moisture vapor transmission rate (MVTR) of less than 0.95 g·mm/m²·day. The microparticles may include metal particles and/or particles having an aspect ratio greater than 2:1. The microparticles are believed to create a hydrophobic tortuous path through the coating composition to minimize transmission of moisture therethrough. The coatings of the present invention provide advantages over other moisture barriers in their applicability as a covering material or as a free film and in their low MVTR.

### DETAILED DESCRIPTION OF THE INVENTION

The present invention is directed to moisture barrier coating compositions comprising a binder comprising a styrenic polymer and microparticles dispersed in the styrenic polymer. The microparticles may be metal particles and/or particles having an aspect ratio greater than 2:1. The coating composition has a moisture vapor transmission rate (MVTR) of less than 0.95 g·mm/m²·day. The phrase “moisture vapor transmission rate” refers to the mass of water vapor that diffuses into a material of a given thickness per unit area per unit time at a specific temperature and humidity differential. Standard tests for MVTR include ASTM E96-00, ASTM F1249-90 and ASTM F32-99, among others. “Moisture barrier” and like terms are used herein to refer to the ability of the coating compositions to prevent transmission of vapor and/or liquid therethrough. “Vapor” refers to the gaseous state of a substance that is liquid or solid at room temperature and atmospheric pressure.

The coating compositions of the present invention have an MVTR less than 0.95 g·mm/m²·day, such as less than 0.65 g·mm/m²·day or less than 0.30 g·mm/m²·day. The coating compositions include a binder of a styrenic polymer having microparticles dispersed therein. In one embodiment, the microparticles are hydrophobic; in another embodiment the microparticles create a tortuous (random and non-linear) path across the coating composition to reduce its MVTR. “Microparticles” refer to particles that are several microns or less in size. As such, the microparticles may be nanosized particles (less than 1 micron in size). Microparticles can have any morphology, and in one embodiment are platelets or flakes. Platelet-type particles within the scope of the present invention may have an average diameter of 1 to 20 microns, such as 2 to 5 or 10 microns. Suitable materials for the microparticles are metal particles and/or particles having an aspect ratio of greater than 2:1. “Metal particles” include, for example, leafing or non-leafing metal flakes, metal fibers and metal whiskers; “metal” includes both metal and any compound that contains metal, such as metal oxides, metal carbides and the like. Particularly suitable are aluminum flakes, copper flakes, bronze flakes, and aluminum oxide flakes. Examples of particles having an aspect ratio of greater than 2:1 include mica, vermiculite, talc, clay, micaeous iron oxide, silica, graphite flakes, glass flakes, phthalocyanine flakes, and the like. It will be appreciated that various metal particles will also have an aspect ratio of greater than 2:1. In certain embodiments, suitable particles have an aspect ratio of 5:1 or greater, such as 10:1 or greater, or 20:1 or greater. Particularly suitable particles are those comprising mica, which can have an aspect ratio of 20 percent or greater, and vermiculite, which can have an aspect ratio of 200:1 or greater. Some suitable particles are sometimes referred to as pigments and/or fillers. The microparticles are present in the coating composition in an amount of at least 10 parts per 100 parts by weight by the binder material (“phr”), such as 50 phr to 250 phr, or 100 phr to 150 phr. Combinations of microparticles can be used.

Styrenic polymers suitable for use in the present coating compositions include polystyrenes and copolymers thereof, such as styrene-butadiene copolymers, poly(styrene-co-maleic anhydride), acrylonitrile-butylene-styrene copolymers, styrene-olefin block copolymers (e.g., KRATON rubbers from Shell Chemical) and poly(styrene sulfonate). Examples of styrene-olefin block copolymers are described in U.S. Pat. Nos. 4,501,842; 5,118,748 and 6,190,816, each being incorporated herein by reference.

Optionally, the styrenic polymers are mixed with a crosslinking agent to form a thermosetting material. Suitable crosslinking agents include compounds containing one or more active hydrogen moieties per molecule. Illustrative of such active hydrogen moieties are —OH (hydroxy group), —SH (thio group), —COOH (carboxylic acid group), and —NHR (amine group), with R being hydrogen, alkyl, aryl or epoxy, all of which may be primary or secondary. These active hydrogen moieties are reactive to free isocyanate groups, forming urethane, urea, thiourea or corresponding linkages depending on the particular active hydrogen moiety being reacted. The crosslinking agents may be monomers, homo-oligomers, co-oligomers, homopolymers or copolymers. Depending on the terminal groups, the oligomeric and polymeric crosslinking agents may be identified as polyols (with —OH terminals only), polyamines (with —NHR terminals only), or amino alcohol oligomers or polymers (with both —OH and —NHR terminals). Such crosslinking agents with a relatively low molecular weight (less than 5,000), and a wide variety of monomeric crosslinking agents, are commonly used as curing agents. The crosslinking agents are generally liquids or solids meltable at relatively low temperatures. Examples of polyolefin polyols are hydrogenated polybutadiene polyols (e.g., POLYTAIL H and POLYTAIL HA from Mitsubishi Kasei Corp. of Tokyo, Japan). The amount of the crosslinking agent is at least 10 parts per 100 parts of the styrenic polymer or at least 20 parts per 100 parts of the styrenic polymer.

Other additives suitable for the barrier layer include, but are not limited to, catalysts such as tertiary amines and coupling agents such as silanes to bond the microparticles to the binder. The coupling agent may be included in the coating composition to enhance adhesion of the coating composition to a substrate such as a layer within a golf ball or other substrates. Any other additives known in the coatings arts can be used as well.

The coating composition has a microparticle to binder weight ratio of 0.5 to 2.5:1, such as 1:1. The specific gravity of the coating composition can be 0.9 g/cm³ to 1.5 g/cm³, such as 1.2 g/cm³ to 1.35 g/cm³. The coating composition may be formed in a single layer or a plurality of layers. When the coating composition is applied to a substrate, the difference in specific gravity between the coating composition and the substrate may be more than 0.1 g/cm³. The thickness of the applied coating composition may be less than 0.2 inch, such as 0.001 inch to 0.01 inch, or 0.002 inch to 0.007 inch.

The coating compositions of the present invention may be applied to an article where reduction in MVTR is desirable, such as flexible packaging, tires and sport balls where resistance to moisture penetration is desirable. One non-limiting example of an article is a golf ball. Portions of a golf ball that incorporate the coating compositions of the present invention include the core, a center within the core, an outer layer of the core, a wound layer, an intermediate layer between the core and the cover, and an inner cover layer of the cover.

The present coating compositions may be bonded to a substrate by an adhesive or a coupling agent. Alternatively, an in situ reaction may be performed to form direct chemical bonds between the coating compositions and the substrate.

The coating compositions may be prepared by dispersing the microparticles with the binder in a non-aqueous solvent system. Suitable solvents for such a solvent-borne dispersion include aromatic hydrocarbons such as xylene and toluene. The dispersion may have a solids content of at least 15 wt. %, such as at least 30 wt. %, or at least 45 wt. %. The dispersion may be applied to a substrate by spraying, dipping, vacuum deposition or reaction injection molding. In a reaction injection molding process, a mixture of the coating composition is spread into an injection molding device and injected through a nozzle into a mold cavity to surround the substrate. Heat and pressure are applied to the mold to cure the coating composition. In addition, the coating composition may be preformed into a semi-cured shape. Specifically, a quantity of the coating composition is placed into a compression mold and molded under sufficient pressure, temperature and time to produce semi-cured, semi-rigid components. The components are then placed around a substrate and cured in a compression mold to achieve a desired size. Alternatively, the coating composition may be shrink-wrapped around a substrate by placing a thin sheet stock of the coating composition against a mold cavity and pressing the sheet stock against the article in a vacuum suction apparatus.

The compositions of the present invention are also useful in the form of free films. As used herein, a “free film” is a film that is not supported by a substrate, but that may be used in conjunction with a substrate to act as a moisture barrier to the substrate.

As used herein, unless otherwise expressly specified, all numbers such as those expressing values, ranges, amounts or percentages may be read as if prefaced by the word “about”, even if the term does not expressly appear. Any numerical range recited herein is intended to include all sub-ranges subsumed therein. Plural encompasses singular and vice versa. Also, as used herein, the term “polymer” is meant to refer to prepolymers, oligomers and both homopolymers and copolymers; the prefix “poly” refers to two or more.

### EXAMPLES

The following examples are intended to illustrate the invention and should not be construed as limiting the invention in any way.

### Example 1

### Part A: Intermediate Resin Composition

An intermediate resin composition was prepared by adding 1,350 grams of toluene (Aromatic 100 from ExxonMobil Chemicals of Houston, Tex.) into a one-gallon container containing 450 grams of methyl isobutyl ketone (MIBK). With a Cowles blade for agitation, 900 grams of resin material (KRATON FG1901X available from Kraton Polymers, Houston, Tex.) was added to the solvent mixture and mixed at high speed to completely dissolve the resin in the MIBK/toluene solvent blend. The temperature was maintained below 140° F. during the Cowles agitation using a water jacket. The intermediate composition had a viscosity in the range of 28,000 cps to 35,000 cps at 33% solids at 75° F.

### Part B: Moisture Barrier Composition

A moisture barrier resin composition was prepared by adding 640 grams of toluene (Aromatic 100) into a one-gallon container containing 160 grams of MIBK. With a Cowles blade for agitation, 615.2 grams of ECKART E30-B leafing aluminum pigment (Eckart America L.P., Louisville, Ky.) was added to the solvent mixture and mixed thoroughly until all of the leafing aluminum was dispersed in the solvent blend 1,200. Grams of the resin composition of Part A were slowly added to the aluminum flake dispersion and mixed thoroughly using the Cowles blade agitator at a medium speed for 15 minutes. The resulting moisture barrier composition had a viscosity in the range of 400 cps to 1,000 cps at 21% solids at 75° F.

### Example 2

A moisture barrier resin composition was prepared by adding 502.5 grams of methyl amyl ketone (MAK) into a one-half gallon container. With a Cowles blade for agitation, 130.7 grams of resin material (KRATON FG1901X) was added to the solvent and mixed at high speed for at least four hours to fully dissolve the resin. The temperature was maintained below 140° F. during the Cowles agitation using a water jacket. The intermediate composition had a viscosity in the range of 1,800 cps to 5,000 cps at 33% solids at 75° F. Another 100 grams of MAK was added to the solution. Under Cowles agitation, 201.4 grams of ECKART E30-B leafing aluminum pigment was slowly added and mixed for at least 90 minutes to disperse the leafing aluminum. An additional 20 grams of MAK was added to the dispersion. The resulting moisture barrier composition had a viscosity in the range of 400 cps to 1,090 cps at 28% solids at 75° F.

### Example 3

The moisture barrier composition of Example 1 was sprayed onto TEDLAR films (E.I. duPont de Nemours &Co., Inc., Wilmington, Del.) taped onto 4″×12″ metal backer panels using siphon air assisted Spraymation, Inc. equipment operated at 1,000 inch/minute traverse speed with a two-inch index and 60 second flash between application coats. Three film thicknesses were prepared: 1.7 mils, 3.4 mils, and 5.2 mils. The films were air dried for approximately 15 to 20 minutes at room temperature and placed in a 250° F. oven for 30 minutes. After cooling, the moisture barrier films were removed from the TEDLAR plates.

The free films were tested for MVTR using a MOCON Instrument operated at 100° F. The free films were sandwiched between two chambers, a lower chamber having a cotton pad saturated with distilled water and an upper chamber through which dry nitrogen passes. Water permeating through the moisture barrier film is carried with the dry nitrogen to a calibrated instrument to determine MVTR. The free films were tested for 24 hours, after which, results were recorded as reported in Table 1. Essentially, no change (0.24 g·mm/²·day or lower) was seen in MVTR for the free films over a one-week period.

TABLE 1

| Film | Film | Total | |
|---|---|---|---|
| thickness | thickness | MVTR | MVTR |
| (mils) | (mm) | (g/m² · day) | (g · mm/m² · day) |
| 1.69 | 0.04 | 5.58 | 0.24 |
| 3.39 | 0.09 | 2.52 | 0.22 |
| 5.16 | 0.13 | 1.66 | 0.22 |

### Example 4

The moisture barrier composition of Example 2 was drawn down onto TEDLAR films taped onto 6″×12″ metal backer panels. The metal panels were placed on a vacuum plate to ensure that the panels were flat during the draw down process. A polyethylene transfer pipette was used to transfer the moisture barrier composition of Example 2 from its container to the TEDLAR films. The composition was drawn down using 3 mils, 6 mils, and 12 mils Bird bars to produce uniform moisture barrier films at three thicknesses. The moisture barrier films were allowed to flash at room temperature for three hours and then were baked for 30 minutes at 180° F. After cooling, the moisture barrier films were removed from the TEDLAR plates.

The free films were tested for MVTR as in Example 3. The results are reported in Table 2. Essentially, no change (0.27 g·mm·m²·day or lower) was seen in MVTR for the free films over a one-week period.

TABLE 2

| Film | Film | Total | |
|---|---|---|---|
| thickness | thickness | MVTR | MVTR |
| (mils) | (mm) | (g/m² · day) | (g · mm/m² · day) |
| 1.30 | 0.03 | 5.59 | 0.18 |
| 1.91 | 0.05 | 3.25 | 0.18 |
| 1.28 | 0.03 | 4.63 | 0.15 |
| 1.95 | 0.05 | 3.25 | 0.16 |
| 2.85 | 0.07 | 3.68 | 0.27 |

While some exemplary embodiments of the present invention have been described above, it will be readily appreciated by those skilled in the art that modifications may be made to the invention without departing from the concept disclosed in the foregoing description. Accordingly, the particular embodiments described in detail herein are illustrative only, and not limiting of the scope of the invention, which is to be given the full breadth of the appended claims and any and all equivalents thereof.

1. A moisture barrier coating composition comprising:
a binder comprising a styrenic polymer; and
microparticles dispersed in the styrenic polymer, the microparticles comprising metal particles and/or particles having an aspect ratio greater than 2:1, wherein the coating composition has a moisture vapor transmission rate of less than 0.95 g·mm/m²·day.

2. The coating composition of claim 1, wherein the moisture vapor transmission rate is less than 0.65 g·mm/m²·day.

3. The coating composition of claim 1, wherein the moisture vapor transmission rate is less than 0.30 g·mm/m²·day.

4. The coating composition of claim 1, wherein the styrenic polymer comprises styrene-butadiene copolymers, poly(styrene-co-maleic anhydride), acrylonitrile-butylene-styrene copolymers, styrene-olefin block copolymers or poly(styrene sulfonate).

5. The coating composition of claim 4, wherein the styrenic polymer comprises styrene-olefin block copolymers.

6. The coating composition of claim 1, wherein the microparticles comprise aluminum flakes.

7. The coating composition of claim 1, wherein the microparticles comprise aluminum oxide.

8. The coating composition of claim 1, wherein the microparticles comprise copper flakes.

9. The coating composition of claim 1, wherein the microparticles comprise bronze flakes.

10. The coating composition of claim 1, wherein the microparticles comprise mica.

11. The coating composition of claim 1, wherein the microparticles comprise vermiculite.

12. The coating composition of claim 1, wherein the microparticles are present in an amount of 50 parts to 250 parts per 100 parts by weight of the styrenic polymer.

13. The coating composition of claim 1, wherein the binder is a thermosetting composition and further comprises a crosslinking agent.

14. The coating composition of claim 13, wherein the crosslinking agent comprises a polyolefin polyol comprising hydrogenated polybutadiene polyols.

15. The coating composition of claim 13, wherein the crosslinking agent is present in an amount of at least 10 parts per 100 parts by weight of the styrenic polymer.

16. The coating composition of claim 1, wherein the crosslinking agent is present in an amount of at least 20 parts per 100 parts by weight of the styrenic polymer.

17. The coating composition of claim 1, further comprising a catalyst.

18. The coating composition of claim 13, wherein the coating composition has a moisture vapor transmission rate of less than 0.65 g·mm/(m²·day).

19. The coating composition of claim 1, wherein the coating composition has a specific gravity between 0.9 g/cm³ and 1.5 g/cm³.

20. The coating composition of claim 1, wherein the composition is dispersed in a non-aqueous solvent system comprising aromatic hydrocarbons or ketones.

21. The coating composition of claim 20, wherein the solvent-borne dispersion has a solids content of at least 15%.

22. The coating composition of claim 20, wherein the solvent-borne dispersion has a solids content of at least 30%.

23. A coated article comprising the coating composition of claim 1 over at least a portion of a substrate.

24. The coated article of claim 23, wherein the coating composition is 0.001 inch to 0.01 inch thick.

25. The coated article of claim 23, wherein the coating composition is 0.002 inch to 0.007 inch thick.

26. The coated article of claim 23, wherein the coating composition is applied to the substrate via spraying.

27. The coated article of claim 23, wherein the microparticles comprise aluminum flakes.

28. The coated article of claim 23, wherein the microparticles comprise aluminum oxide.

29. The coated article of claim 23, wherein the coating composition includes a hydrophobic tortuous path through the coating composition.

30. The coated article of claim 23, wherein the specific gravity of the coating composition differs from the specific gravity of the substrate by more than 0.1 g/cm³.

31. A free film of a coating composition comprising:
a binder comprising a styrenic polymer; and
microparticles dispersed in the styrenic polymer, the microparticles comprising metal particles and/or particles having an aspect ratio greater than 2:1, wherein the free film has a moisture vapor transmission rate of less than 0.95 g·mm/m²·day.

32. The free film of claim 31, wherein the styrenic polymer comprises styrene-butadiene copolymers, poly(styrene-co-maleic an hydride), acrylonitrile-butylene-styrene copolymers, styrene-olefin block copolymers or poly(styrene sulfonate).

33. The free film of claim 32, wherein the styrenic polymer comprises styrene-olefin block copolymers.

34. The free film of claim 31, wherein the microparticles comprise aluminum flakes.

35. The free film of claim 34, wherein the film is 0.001 inch to 0.01 inch thick.
